(19) United States
(12) Patent Application Publication
(10) Pub. No.: US 2024/0093129 A1
(43) Pub. Date: Mar. 21, 2024

(54) WATER-SOLUBLE UNIT DOSE ARTICLE COMPRISING LIQUID LAUNDRY DETERGENT COMPOSITION WHICH COMPRISES POLYETHYLENE GLYCOL

(71) Applicant: The Procter & Gamble Company, Cincinnati, OH (US)

(72) Inventors: Qiuyang HE, Beijing (CN); Yanjie WENG, Beijing (CN); Ming TANG, Beijing (CN)

(21) Appl. No.: 18/454,864

(22) Filed: Aug. 24, 2023

(30) Foreign Application Priority Data
Sep. 16, 2022 (WO) PCT/CN2022/119319
Jul. 18, 2023 (WO) PCT/CN2023/107881

(51) Int. Cl. C11D 17/04; C11D 1/83; C11D 3/20; C11D 3/37; C11D 3/43; C11D 11/00

(52) U.S. Cl. CPC C11D 17/043; C11D 1/83; C11D 3/2044; C11D 3/2065; C11D 3/2079; C11D 3/3707; C11D 3/43; C11D 11/0017; C11D 1/72

(57) ABSTRACT

The present invention relates to water-soluble unit dose articles comprising a liquid laundry detergent composition which comprises polyethylene glycol having a weight average molecular weight of from about 150 to about 300 Daltons.

### FIELD OF THE INVENTION

The present invention relates to water-soluble unit dose articles comprising a liquid laundry detergent composition which comprises polyethylene glycol having a weight average molecular weight of from about 150 to about 300 Daltons.

### BACKGROUND OF THE INVENTION

Water-soluble unit dose articles are liked by consumers due their convenience and ease of use. Consumers also like the fact that they do not need to measure a detergent dose and so this eliminates accidental spillage during the dosing operation. Accidental dosage can be messy and inconvenient. The water-soluble unit dose article comprises the water-soluble film shaped such that the unit dose article comprises at least one internal compartment surrounded by the water-soluble film. Preferred film materials are preferably polymeric materials. The film material can, for example, be obtained by casting, blow-moulding, extrusion or blown extrusion of the polymeric material, as known in the art.

There are various aspects of requirements for detergent unit dose articles. Such requirements include stability, physical properties for films and “weeping” performance. First of all, similarly as liquid detergent products, the liquid contained in the detergent unit dose articles need to be stable during the shelf life, i.e., no phase separation or flocculation. Also, “weeping” phenomenon occurs during the storage of the unit dose articles, i.e., some minor liquid composition comes out of the unit dose articles through the film. High level of “weeping” is not acceptable for consumers. Furthermore, in order to keep the unit dose article in a desirable state before use (for example, not being too floppy and no premature breakage), the film material need to have appropriate physical properties. Particularly, swelling performance of film materials may be important. The film material may swell or de-swell after it contacts the liquid contained in the unit dose articles due to the interaction between the film material and some ingredients in the liquid. Too much swelling gives floppy unit dose articles which are not desirable for consumers and too much de-swelling renders unit dose articles sensitive to breakage. All these aspects need to be considered in the design of unit dose articles in order to achieve an overall good performance in all these aspects, e.g. an improved balance among these aspects.

Conventionally, unit dose articles contain a non-aqueous solvent (such as monoalcohols, diols, polyols, glycol ethers) to disperse or suspend active ingredients. It was surprisingly found that a water-soluble unit dose article can provide an improved balance among the aspects as mentioned above when such water-soluble unit dose article is formed by using a liquid detergent composition comprising polyethylene glycol having a weight average molecular weight of from about 150 to about 300 Daltons in combination with the non-aqueous solvent.

### SUMMARY OF THE INVENTION

The present invention in one aspect relates to a water-soluble unit dose article comprising a water-soluble film and a liquid laundry detergent composition wrapped with the water-soluble film, wherein the liquid laundry detergent composition comprises from 1% to 25%, by weight of the composition, of polyethylene glycol having a weight average molecular weight of from about 150 to about 300 Daltons, and from 0.1% to 30% of a non-aqueous solvent, by weight of the composition, wherein the liquid laundry detergent composition comprises less than 15% by weight of the composition of water.

It may be an advantage of the water-soluble unit dose article according to the present application to provide an improved balance among stability, physical property and “weeping” phenomenon.

### DETAILED DESCRIPTION OF THE INVENTION

### Definitions

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the term “laundry detergent composition” means a composition for cleaning soiled materials, including fabrics. Such compositions may be used as a pre-laundering treatment, a post-laundering treatment, or may be added during the rinse or wash cycle of the laundering operation. The term of “liquid laundry detergent composition” herein refers to compositions that are in a form selected from the group consisting of pourable liquid, gel, cream, and combinations thereof. The term of “unit dose laundry detergent composition” herein refers to a water-soluble pouch containing a certain volume of liquid wrapped with a water-soluble film.

As used herein, the terms “non-aqueous solvent” means any non-aqueous solvent except the polyethylene glycol contained in the water-soluble unit dose article according to the present disclosure (e.g., the polyethylene glycol having a weight average molecular weight of from about 150 to about 300 Daltons).

As used herein, the term “alkyl” means a hydrocarbyl moiety which is branched or unbranched, substituted or unsubstituted. Included in the term “alkyl” is the alkyl portion of acyl groups.

As used herein, the term “washing solution” refers to the typical amount of aqueous solution used for one cycle of laundry washing, preferably from 1 L to 50 L, alternatively from 1 L to 20 L for hand washing and from 10 L to 50 L for machine washing.

As used herein, the term “soiled fabric” is used non-specifically and may refer to any type of natural or artificial fibers, including natural, artificial, and synthetic fibers, such as, but not limited to, cotton, linen, wool, polyester, nylon, silk, acrylic, and the like, as well as various blends and combinations.

### Water-Soluble Unit Dose Article

The present invention discloses a water-soluble unit dose article comprising a water-soluble film and a liquid laundry detergent composition. Particularly, the liquid laundry detergent composition is wrapped with the water-soluble film. The water-soluble film and the liquid detergent composition are described in more detail below.

The water-soluble unit dose article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments. The compartments may be arranged in superposed orientation, i.e. one positioned on top of the other. In such an orientation the unit dose article will comprise three films, top, middle and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the detergent composition according to the present invention may be comprised in at least one of the compartments. It may for example be comprised in just one compartment, or may be comprised in two compartments, or even in three compartments.

Each compartment may comprise the same or different compositions. The different compositions could all be in the same form, or they may be in different forms.

The water-soluble unit dose article may comprise at least two internal compartments, wherein the liquid laundry detergent composition is comprised in at least one of the compartments, preferably wherein the unit dose article comprises at least three compartments, wherein the detergent composition is comprised in at least one of the compartments.

### Water-Soluble Film

The water-soluble film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns: 5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

The water-soluble film material may be obtained by casting, blow-moulding, extrusion or blown extrusion of the polymeric material, as known in the art.

The water-soluble film comprises polyvinylalcohol. The polyvinylalcohol may be present between 50% and 95%, preferably between 55% and 90%, more preferably between 60% and 80% by weight of the water soluble film. The polyvinylalcohol preferably comprises polyvinyl alcohol homopolymer, polyvinylalcohol copolymer, or a mixture thereof. Preferably, the water-soluble film comprises a blend of polyvinylalcohol homopolymers and/or anionic polyvinylalcohol copolymers, preferably wherein the polyvinylalcohol copolymers are selected from sulphonated and carboxylated anionic polyvinylalcohol copolymers especially carboxylated anionic polyvinylalcohol copolymers, most preferably the water-soluble film comprises a blend of a polyvinylalcohol homopolymer and a carboxylated anionic polyvinylalcohol copolymer, or a blend of polyvinylalcohol homopolymers. Alternatively, the polyvinylalcohol comprises an anionic polyvinyl alcohol copolymer, most preferably a carboxylated anionic polyvinylalcohol copolymer. When the polyvinylalcohol in the water soluble film is a blend of a polyvinylalcohol homopolymer and a carboxylated anionic polyvinylalcohol copolymer, the homopolymer and the anionic copolymer are present in a relative weight ratio of 90/10 to 10/90, preferably 80/20 to 20/80, more preferably 70/30 to 50/50. Without wishing to be bound by theory, the term “homopolymer” generally includes polymers having a single type of monomeric repeating unit (e.g., a polymeric chain comprising or consisting of a single monomeric repeating unit). For the particular case of polyvinylalcohol, the term “homopolymer” further includes copolymers having a distribution of vinyl alcohol monomer units and optionally vinyl acetate monomer units, depending on the degree of hydrolysis (e.g., a polymeric chain comprising or consisting of vinyl alcohol and vinyl acetate monomer units). In the case of 100% hydrolysis, a polyvinylalcohol homopolymer can include only vinyl alcohol units. Without wishing to be bound by theory, the term “copolymer” generally includes polymers having two or more types of monomeric repeating units (e.g., a polymeric chain comprising or consisting of two or more different monomeric repeating units, whether as random copolymers, block copolymers, etc.). For the particular case of polyvinylalcohol, the term “copolymer” (or “polyvinylalcohol copolymer”) further includes copolymers having a distribution of vinyl alcohol monomer units and vinyl acetate monomer units, depending on the degree of hydrolysis, as well as at least one other type of monomeric repeating unit (e.g., a ter- (or higher) polymeric chain comprising or consisting of vinyl alcohol monomer units, vinyl acetate monomer units, and one or more other monomer units, for example anionic monomer units). In the case of 100% hydrolysis, a polyvinylalcohol copolymer can include a copolymer having vinyl alcohol units and one or more other monomer units, but no vinyl acetate units. Without wishing to be bound by theory, the term “anionic copolymer” includes copolymers having an anionic monomer unit comprising an anionic moiety. General classes of anionic monomer units which can be used for the anionic polyvinyl alcohol co-polymer include the vinyl polymerization units corresponding to monocarboxylic acid vinyl monomers, their esters and anhydrides, dicarboxylic monomers having a polymerizable double bond, their esters and anhydrides, vinyl sulfonic acid monomers, and alkali metal salts of any of the foregoing. Examples of suitable anionic monomer units include the vinyl polymerization units corresponding to vinyl anionic monomers including vinyl acetic acid, maleic acid, monoalkyl maleate, dialkyl maleate, monomethyl maleate, dimethyl maleate, maleic anyhydride, fumaric acid, monoalkyl fumarate, dialkyl fumarate, monomethyl fumarate, dimethyl fumarate, fumaric anyhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sulfoethyl acrylate, alkali metal salts of the foregoing (e.g., sodium, potassium, or other alkali metal salts), esters of the foregoing (e.g., methyl, ethyl, or other C1-C4 or C6 alkyl esters), and combinations thereof (e.g., multiple types of anionic monomers or equivalent forms of the same anionic monomer). The anionic monomer may be one or more acrylamido methylpropanesulfonic acids (e.g., 2-acrylamido-1-methylpropanesulfonic acid, 2-acrylamido-2-methylpropanesulfonic acid, 2-methylacrylamido-2-methylpropanesulfonic acid), alkali metal salts thereof (e.g., sodium salts), and combinations thereof. Preferably, the anionic moiety of the first anionic monomer unit is selected from a sulphonate, a carboxylate, or a mixture thereof, more preferably a carboxylate, most preferably an acrylate, a methacrylate, a maleate, or a mixture thereof. Preferably, the anionic monomer unit is present in the anionic polyvinyl alcohol copolymer in an average amount in a range of between 1 mol. % and 10 mol. %, preferably between 2 mol. % and 5 mol. %. Preferably, the polyvinyl alcohol, and/or in case of polyvinylalcohol blends the individual polyvinylalcohol polymers, have an average viscosity (μ1) in a range of between 4 mPa·s and 30 mPa·s, preferably between 10 mPa·s and 25 mPa·s, measured as a 4% polyvinyl alcohol copolymer solution in demineralized water at 20 degrees C. The viscosity of a polyvinyl alcohol polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. It is well known in the art that the viscosity of an aqueous water-soluble polymer solution (polyvinylalcohol or otherwise) is correlated with the weight-average molecular weight of the same polymer, and often the viscosity is used as a proxy for weight-average molecular weight. Thus, the weight-average molecular weight of the polyvinylalcohol can be in a range of 30,000 to 175,000, or 30,000 to 100,000, or 55,000 to 80,000. Preferably, the polyvinyl alcohol, and/or in case of polyvinylalcohol blends the individual polyvinylalcohol polymers, have an average degree of hydrolysis in a range of between 75% and 99%, preferably between 80% and 95%, most preferably between 85% and 95%. A suitable test method to measure the degree of hydrolysis is as according to standard method JIS K6726.

Preferably, the water-soluble film comprises a non-aqueous plasticizer. Preferably, the non-aqueous plasticizer is selected from polyols, sugar alcohols, and mixtures thereof. Suitable polyols include polyols selected from the group consisting of glycerol, diglycerin, ethylene glycol, diethylene glycol, triethyleneglycol, tetraethylene glycol, polyethylene glycols up to 400 molecular weight, neopentyl glycol, 1,2-propylene glycol, 1,3-propanediol, dipropylene glycol, polypropylene glycol, 2-methyl-1,3-propanediol, trimethylolpropane and polyether polyols, or a mixture thereof. Suitable sugar alcohols include sugar alcohols selected from the group consisting of isomalt, maltitol, sorbitol, xylitol, erythritol, adonitol, dulcitol, pentaerythritol and mannitol, or a mixture thereof. More preferably the non-aqueous plasticizer is selected from glycerol, 1,2-propanediol, dipropylene glycol, 2-methyl-1,3-propanediol, trimethylolpropane, triethyleneglycol, polyethyleneglycol, sorbitol, or a mixture thereof, most preferably selected from glycerol, sorbitol, trimethylolpropane, dipropylene glycol, and mixtures thereof. One particularly suitable plasticizer system includes a blend of glycerol, sorbitol and trimethylol propane. Another particularly suitable plasticizer system includes a blend of glycerin, dipropylene glycol, and sorbitol. Preferably, the film comprises between 5% and 50%, preferably between 10% and 40%, more preferably between 20% and 30% by weight of the film of the non-aqueous plasticizer.

Preferably, the water-soluble film comprises a surfactant. Preferably, the water-soluble film comprises a surfactant in an amount between 0.1% and 2.5%, preferably between 1% and 2% by weight of the water-soluble film. Suitable surfactants can include the nonionic, cationic, anionic and zwitterionic classes. Suitable surfactants include, but are not limited to, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). Other suitable surfactants include dioctyl sodium sulfosuccinate, lactylated fatty acid esters of glycerol and propylene glycol, lactylic esters of fatty acids, sodium alkyl sulfates, polysorbate 20, polysorbate 60, polysorbate 65, polysorbate 80, lecithin, acetylated fatty acid esters of glycerol and propylene glycol, and acetylated esters of fatty acids, and combinations thereof.

Preferably the water-soluble film according to the invention comprises lubricants/release agents. Suitable lubricants/release agents can include, but are not limited to, fatty acids and their salts, fatty alcohols, fatty esters, fatty amines, fatty amine acetates and fatty amides. Preferred lubricants/release agents are fatty acids, fatty acid salts, and fatty amine acetates. The amount of lubricant/release agent in the water-soluble film is in a range of from 0.02% to 1.5%, preferably from 0.1% to 1% by weight of the water-soluble film.

Preferably, the water-soluble film comprises fillers, extenders, antiblocking agents, detackifying agents or a mixture thereof. Suitable fillers, extenders, antiblocking agents, detackifying agents or a mixture thereof include, but are not limited to, starches, modified starches, crosslinked polyvinylpyrrolidone, crosslinked cellulose, microcrystalline cellulose, silica, metallic oxides, calcium carbonate, talc and mica. Preferred materials are starches, modified starches and silica. Preferably, the amount of filler, extender, antiblocking agent, detackifying agent or mixture thereof in the water-soluble film is in a range of from 0.1% to 25%, preferably from 1% to 10%, more preferably from 2% to 8%, most preferably from 3% to 5% by weight of the water-soluble film. In the absence of starch, one preferred range for a suitable filler, extender, antiblocking agent, detackifying agent or mixture thereof is from 0.1% to 1%, preferably 4%, more preferably 6%, even more preferably from 1% to 4%, most preferably from 1% to 2.5%, by weight of the water-soluble film.

Preferably the water-soluble film according to the invention has a residual moisture content of at least 4%, more preferably in a range of from 4% to 15%, even more preferably of from 5% to 10% by weight of the water-soluble film as measured by Karl Fischer titration.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films include those supplied by Monosol under the trade references M8630, M8900, M8779, M8310.

The film may be opaque, transparent or translucent. The film may comprise a printed area. The area of print may be achieved using standard techniques, such as flexographic printing or inkjet printing. Preferably, the ink used in the printed area comprises between 0 ppm and 20 ppm, preferably between 0 ppm and 15 ppm, more preferably between 0 ppm and 10 ppm, even more preferably between 0 ppm and 5 ppm, even more preferably between 0 ppm and 1 ppm, even more preferably between 0 ppb and 100 ppb, most preferably 0 ppb dioxane. Those skilled in the art will be aware of known methods and techniques to determine the dioxane level within the ink formulations.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

Preferably, the water-soluble film or water-soluble unit dose article or both are coated in a lubricating agent, preferably, wherein the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

Preferably, the water-soluble film, and each individual component thereof, independently comprises between 0 ppm and 20 ppm, preferably between 0 ppm and 15 ppm, more preferably between 0 ppm and 10 ppm, even more preferably between 0 ppm and 5 ppm, even more preferably between 0 ppm and 1 ppm, even more preferably between 0 ppb and 100 ppb, most preferably 0 ppb dioxane. Those skilled in the art will be aware of known methods and techniques to determine the dioxane level within water-soluble films and ingredients thereof.

### Liquid Laundry Detergent Composition

The water-soluble unit dose article comprises a liquid laundry detergent composition. The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules.

The liquid detergent composition can be used in a fabric hand wash operation or may be used in an automatic machine fabric wash operation.

The liquid laundry detergent composition may comprise from 1% to 25%, by weight of the composition, of polyethylene glycol having a weight average molecular weight of from about 150 to about 300 Daltons. Preferably, the polyethylene glycol may be present at a level of from 4% to 23%, preferably from 8% to 21%, more preferably from 10% to 20%, for example 2%, 3%, 5%, 7%, 12%, 15%, 17%, 20%, or any ranges therebetween, by weight of the composition.

The polyethylene glycol may have a weight average molecular weight of from about 150 to about 300 Daltons, preferably from about 150 to about 250 Daltons, e.g. 150 Daltons, 200 Daltons, 250 Daltons and any ranges therebetween.

The liquid laundry detergent composition may further comprise from 0.1% to 30%, preferably from 1% to 30%, more preferably from 2% to 30%, most preferably from 3% to 25%, for example 2%, 3%, 5%, 7%, 12%, 15%, 17%, 20%, 25% or any ranges therebetween, by weight of the composition, of a non-aqueous solvent. Preferably, the non-aqueous solvent may be selected from the group consisting of monoalcohols, diols, polyols, glycol ethers and any combinations thereof. More preferably, the non-aqueous solvent may be selected from the group consisting of ethanol, propanol, isopropanol, terpineol, ethylene glycol, 1,2-propanediol, 1,3-propanediol, butanediol, glycerine, butanetriol, pentaerythritol, dipropylene glycol (DPG), tripropylene glycol (TPG), polypropylene glycol (PPG), n-butoxy propoxy propanol (nBPP), diethylene glycol, 2-ethoxyethanol, 2-butoxyethanol, polyethyleneglycols having a weight average molecular weight of at least 400 Daltons, and any combinations thereof.

The term of “diol solvent” as used herein means alcohol compounds having two hydroxyl groups. The term of “polyol solvent” as used herein means alcohol compounds having three or more hydroxyl groups. The term of “hydroxyl ether solvent” as used herein means ether compounds having at least one hydroxyl group.

In some embodiments, 1,2-propanediol may be present in an amount ranging from 0.1% to 15%, preferably from 1% to 14%, more preferably from 3% to 13%, by weight of the composition.

In some embodiments, glycerine may be present in an amount ranging from 0.1% to 10%, preferably from 1% to 9%, more preferably from 3% to 8%, by weight of the composition.

In some embodiments, liquid laundry detergent composition may comprise 1,2-propanediol, glycerine and polyethylene glycol having a weight average molecular weight of from about 150 to about 300 Daltons in which the total amount of 1,2-propanediol, glycerine and polyethylene glycol may range from 5% to 50%, preferably from 10% to 45%, more preferably from 15% to 40%, by weight of the composition.

In some embodiments, liquid laundry detergent composition may comprise 1,2-propanediol and polyethylene glycol having a weight average molecular weight of from about 150 to about 300 Daltons in which the weight ratio of 1,2-propanediol and the polyethylene glycol is from 0.1 to 0.6, preferably from 0.15 to 0.5, and more preferably from 0.2 to 0.4.

In some embodiments, liquid laundry detergent composition may comprise glycerine and polyethylene glycol having a weight average molecular weight of from about 150 to about 300 Daltons in which the weight ratio of glycerine and the polyethylene glycol is from 0.1 to 0.7, preferably from 0.2 to 0.6 and more preferably from 0.3 to 0.5.

In some embodiments, liquid laundry detergent composition may comprise 1,2-propanediol and glycerine in which the weight ratio of 1,2-propanediol and glycerine is from 0.2 to 5, preferably from 0.4 to 3, and more preferably from 0.5 to 1.

Preferably the liquid laundry detergent composition comprises less than 14%, preferably less than 13%, more preferably less than 12% by weight of the liquid laundry detergent composition of water.

The liquid laundry detergent composition may comprise a cleaning or care polymer, preferably wherein the cleaning or care polymer is selected from an ethoxylated or mixed ethoxylated/propoxylated polyethyleneimine, alkoxylated polyalkyl phenol, an amphiphilic graft copolymer, an optionally anionically modified polyester terephthalate, an optionally cationically modified hydroxyethylcellulose, a carboxymethylcellulose or a mixture thereof.

The water-soluble unit dose article may comprise an adjunct ingredient selected from hueing dyes, polymers, builders, dye transfer inhibiting agents, dispersants, enzymes, enzyme stabilizers, catalytic materials, bleach, bleach activators, polymeric dispersing agents, anti-redeposition agents, suds suppressors, aesthetic dyes, opacifiers, perfumes, perfume delivery systems, structurants, hydrotropes, processing aids, pigments and mixtures thereof.

Preferably, the laundry detergent composition has a pH between 6 and 10, between 6.5 and 8.9, or between 7 and 8, wherein the pH of the laundry detergent composition is measured as a 10% product concentration in demineralized water at 20° C.

In some embodiments, the liquid laundry detergent composition is Newtonian.

In some other embodiments, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The liquid laundry detergent composition may have a viscosity of at least 2 Pa·s at a shear rate of 0.5 s⁻¹ as measured using a TA Rheometer AR2000 at 25° C., preferably wherein the liquid detergent composition has a viscosity of between 2 Pa·s and 35 Pa·s, preferably between 2.5 Pa·s and Pa·as, more preferably between 3 Pa·s and 25 Pa·s, even more preferably between 5 Pa·s and Pa·s, most preferably between 10 Pa·s and 16 Pa·s at a shear rate of 0.5 s⁻¹ as measured using a TA Rheometer AR2000 at 25° C. The liquid laundry detergent composition may be characterized by a high shear viscosity ranging from about 100 to about 900 mPa s, preferably from about 150 to about 800 mPa s, more preferably from about 200 to about 600 mPa s, measured at a shear rate of about 1000 s⁻¹ and at a temperature of about 20° C. The fluid may be preferably a non-Newtonian fluid with shear-thinning properties, hence is further characterized by a low shear viscosity ranging from about 1000 mPa·s to about 10000 mPa·s, preferably from about 1500 mPa·s to about 7500 mPa·s, more preferably from about 2000 mPa·s to about 5000 mPa·s when measured at a shear rate of about 0.5 s⁻¹.

### Surfactant

The liquid detergent composition of the present invention may further comprise from 0.1% to 70%, preferably from 1% to 60%, more preferably from 5% to 50%, most preferably from 10% to 45%, by weight of the composition, of a surfactant. Preferably, the surfactant may be selected from the group consisting of C₆-C₂₀ alkyldimethyl amine oxides, C₆₋₂₀ amido alkyl dimethyl amine oxides, C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), fatty acids, alkyl alkoxylated alcohols, alkyl alkoxylated phenols, alkyl polysaccharides, alkyl polyglycosides, methyl ester ethoxylates, polyhydroxy fatty acid amides, alkoxylated fatty acid esters, sucrose esters, sorbitan esters and alkoxylated derivatives of sorbitan esters, and any combinations thereof. More preferably, the surfactant may comprise a C₆-C₂₀ alkyldimethyl amine oxide, a C₆-C₂₀ LAS, and a C₆-C₂₀ alkoxylated alcohol having a weight average degree of alkoxylation ranging from 1 to 20 preferably a C₆-C₂₀ ethoxylated alcohol having a weight average degree of ethoxylation ranging from 1 to 20.

Preferably, the anionic surfactant may be selected from the group consisting of C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), fatty acids and any combinations thereof. More preferably, the anionic surfactant system may comprise a C₆-C₂₀ LAS and optionally an additional anionic surfactant such as a C₆-C₂₀ AS and/or a C₆-C₂₀ AAS preferably a C₆-C₂₀ alkyl ethoxylated sulfate having a weight average degree of ethoxylation ranging from 1 to 7. In one embodiment, LAS is C₁₀-C₁₆ LAS, preferably C₁₂-C₁₄ LAS.

Preferably, the non-ionic surfactant may be selected from the group consisting of alkyl alkoxylated alcohols, alkyl alkoxylated phenols, alkyl polysaccharides, alkyl polyglycosides, methyl ester ethoxylates, polyhydroxy fatty acid amides, alkoxylated fatty acid esters, sucrose esters, sorbitan esters and alkoxylated derivatives of sorbitan esters, and any combinations thereof. More preferably, the nonionic surfactant may comprise a C₈-C₁₈ ethoxylated alcohol having a weight average degree of ethoxylation ranging from 1 to 20, preferably from 5 to 15, more preferably from 5 to 10.

In some embodiments, the surfactant may comprise an anionic surfactant and a non-ionic surfactant in which the anionic surfactant comprises a C₆-C₂₀ LAS and optionally a C₆-C₂₀ AS and/or a C₆-C₂₀ AAS and the non-ionic surfactant comprises a C₆-C₂₀ alkoxylated alcohol having a weight average degree of alkoxylation ranging from 1 to 20, preferably from 5 to 15, more preferably from 5 to 10.

In some embodiments, the weight ratio of LAS to AAₓS is at least 0.6, preferably at least 0.8, more preferably at least 0.9, most preferably at least 1, for example 0.6, 0.7, 0.8, 0.9, 1, 1.2, 1.5, 2, 2.5, 3, 4, 5, 8, 10 or any ranges therebetween.

In some embodiments, the C₆-C₂₀ LAS is present in an amount ranging from 1% to 30%, preferably from 2% to 25%, more preferably from 3% to 20%, by weight of the composition.

In some embodiments, the C₆-C₂₀ AAS is present in an amount ranging from 1% to 20%, preferably from 2% to 15%, more preferably from 3% to 10%, by weight of the composition.

In some embodiments, the C₆-C₂₀ alkoxylated alcohol is present in an amount ranging from 1% to 60%, preferably from 2% to 45%, more preferably from 3% to 30%, most preferably from 3% to 20%, by weight of the composition.

In some embodiments, the liquid laundry detergent composition may further comprise from 1% to 30%, preferably from 2% to 25%, more preferably from 3% to 20%, by weight of the composition, of an amine oxide

In some embodiments, the liquid laundry detergent composition may further comprise from 0.1% to 10%, preferably from 0.5% to 8%, more preferably from 0.7% to 6%, most preferably from 1% to 3, by weight of the composition, of a fatty acid In an embodiment, the liquid laundry detergent composition may comprise:
a) from 10% to 20%, by weight of the composition, of polyethylene glycol having a weight average molecular weight of from about 150 to about 250 Daltons,
b) from 5% to 20%, by weight of the composition, of a non-aqueous solvent which comprises 1,2-propanediol and glycerine, and
c) from 30%% to 45%, by weight of the composition, of a surfactant which comprises a C₆-C₂₀ LAS, a C₆-C₂₀ AAS, and a C₆-C₂₀ alkoxylated alcohol having a weight average degree of alkoxylation ranging from 5 to 10.

### Method of Washing

A further aspect of the present invention is a method of washing comprising the steps of adding the water-soluble unit dose article according to the present invention to sufficient water to dilute the liquid detergent composition by a factor of at least 300 fold to create a wash liquor and contacting items to be washed with said wash liquor.

### Packaged Product

A further aspect of the present invention is a packaged product comprising a recloseable container and at least one water-soluble unit dose article according to the present invention comprised therein.

Those skilled in the art will be aware of relevant storage receptacles. Preferably, the storage receptacle is a flexible, preferably resealable, bag, a rigid, preferably recloseable, tub or a mixture thereof, preferably, wherein the storage receptacle comprises a child resistant closure. Those skilled in the art will be aware of suitable child resistant closures.

The package may be made from any suitable material. The container may be made from metallic materials, Aluminium, plastic materials, cardboard materials, laminates, cellulose pulp materials or a mixture thereof. The package may be made from a plastic material, preferably a polyolefin material. The package may be made from polypropylene, polystyrene, polyethylene, polyethylene terephthalate, PVC or a mixture thereof or more durable engineering plastics like Acrylonitrile Butadiene Styrene (ABS), Polycarbonates, Polyamides and the like The material used to make the container may comprise other ingredients, such as colorants, preservatives, plasticisers, UV stabilizers, Oxygen, perfume and moisture barriers recycled materials and the like.

### Test Method

### Test 1: Stability Test

Stability test is conducted through visual inspection as below:
1) Prepare liquid composition samples to be tested by mixing ingredients in 30 ml transparent glass bottles;
2) Store the samples prepared in Step 1) under 25° C. for 4 weeks;
3) Visually inspect the samples to determine if they are still homogeneous systems after Step 2). If there is any phase separation such as the formation of separated layers or flocculation, it is determined as “fail”. If there is no phase separation, it is determined as “pass”.

### Test 2: Weeping Test for Unit Dose Articles

In this test, Corneometer (available from BMM&DI Clinical Sciences company) is used to measure weeping level of unit dose articles. The Measurement Principle is based on capacitance measurement of a dielectric medium. For Liquitabs it measures the dielectric constant of water and other substances which penetrate the PVA-Film.

The unit dose articles need to be pre-conditioned in room condition 25° C. or 32° C., 80% RH CTCH for 48 hrs.

To measure the weeping level, put the sensor of the Corneometer on the surface of unit dose articles and press it down slowly until a measurement is registered. For a multi compartment unit dose article, the bottom layer is measured 5 times and each top layer 2 times.

Weeping level can then be defined by correlating average, lower and upper limit of the range with the Weeping Scale being reflected below.

| Weeping Category | % Weeping |
|---|---|
| Light | <50 |
| Light/Medium | 50-65 |
| Medium | 65-80 |
| Heavy | >80 |

### Test 3: Physical Property Test for Film in Unit Dose Articles

A 76 μm thick polyvinylalcohol based water soluble film, as provided by the Monosol company, was used to assess film physical properties. Film physical properties was defined through measuring film thickness increase %, area increase %, volume increase %, maximum tensile stress, and tensile strain % after having subjected the water-soluble film to an ageing experiment through immersing in liquid detergent composition samples as above. Three film samples of 12.5 cm by 2.5 cm was immersed within 100 ml of test liquid by 1) selecting a clean 125 ml plastic beaker, 2) add 100 ml example formulation to be tested into the beaker, 3) carefully fully immerse the film sheets to be tested in the liquid, ensuring that the film is free of wrinkles and that no air bubbles are in contact with the film, 4) closing the container and 5) storing the closed container for 5 days at 50° C., 80% RH CTCH. After ageing, the film was removed from the formulation example and gently wiped dry with a soft dry liquid absorbing paper, followed immediately by measuring the post film immersion and stress-strain profile. The film thickness increase %, area increase %, volume increase % were measured by a ruler; maximum tensile stress, and tensile strain % were measured using an Instron instrument which is commercially available from the Instron company.

### EXAMPLES

### Example 1: Improved Balance Among Stability, Physical Property and Weeping Performance of Unit Dose Articles Containing PEG 150 to 300 and a Non-Aqueous Solvent

The following liquid detergent formulations were prepared using standard mixing techniques and equipment known to those skilled in the art. Samples 1 to 5 and 8 contain polyethylene glycol (PEG) with different molecular weights (from 50 Daltons to 600 Daltons) as well as a non-aqueous solvent. Sample 6 contains a non-aqueous solvent only without a polyethylene glycol and Sample 7 contains PEG 200 only. In order to find out unit dose articles having an improved balance among stability, physical property and weeping performance, the samples were tested as below.

TABLE 1

| Ingredients | | | | | | | | |
|---|---|---|---|---|---|---|---|---|
| (weight %) | Sample 1 | Sample 2 | Sample 3 | Sample 4 | Sample 5 | Sample 6 | Sample 7 | Sample 8 |
| Nonionic | 13.5 | 13.5 | 13.5 | 13.5 | 13.5 | 13.5 | 13.5 | 2.3 |
| Surfactant¹ | | | | | | | | |
| Anionic | 9.4 | 9.4 | 9.4 | 9.4 | 9.4 | 9.4 | 9.4 | 16.4 |
| surfactant A² | | | | | | | | |
| Anionic | 19.9 | 19.9 | 19.9 | 19.9 | 19.9 | 19.9 | 19.9 | 24 |
| surfactant B³ | | | | | | | | |
| Fatty Acid | 6.5 | 6.5 | 6.5 | 6.5 | 6.5 | 6.5 | 6.5 | 6.6 |
| MEA | 6.7 | 6.7 | 6.7 | 6.7 | 6.7 | 6.7 | 6.7 | 8.7 |
| SRP | 5.6 | 5.6 | 5.6 | 5.6 | 5.6 | 5.6 | 5.6 | 4.4 |
| polymer⁴ | | | | | | | | |
| Potassium | 0.4 | 0.4 | 0.4 | 0.4 | 0.4 | 0.4 | 0.4 | 0.4 |
| sulfite | | | | | | | | |
| 1,2- | 3.4 | 3.4 | 3.4 | 3.4 | 3.4 | 18.0 | — | 3.4 |
| propanediol | | | | | | | | |
| Glycerine | 5.3 | 5.3 | 5.3 | 5.3 | 5.3 | 5.3 | — | 5.3 |
| Polyethylene | 14.6 | 14.6 | 14.6 | 14.6 | 14.6 | — | 23.3 | 14.6 |
| glycol (PEG) | | | | | | | | |
| Water | 10.3 | 10.3 | 10.3 | 10.3 | 10.3 | 10.3 | 10.3 | 10.3 |
| Misc. | balance | balance | balance | balance | balance | balance | balance | balance |
| Molecular | 50 | 100 | 200 | 400 | 600 | — | 200 | 200 |
| weight of | Daltons | Daltons | Daltons | Daltons | Daltons | | Daltons | Daltons |
| PEG | | | | | | | | |
| Note | PEG50 | PEG100 | PEG200 | PEG400 | PEG600 | Non- | PEG200 | PEG200 |
| | + | + | + | + | + | aqueous | only | + |
| | Non- | Non- | Non- | Non- | Non- | Solvent | | Non- |
| | aqueous | aqueous | aqueous | aqueous | aqueous | only | | aqueous |
| | Solvent | Solvent | Solvent | Solvent | Solvent | | | Solvent |

¹Nonionic surfactant: C₁₂-C₁₄ ethoxylated alcohol
²Anionic surfactant A: C₁₂-C₁₄ alkyl ethoxylated sulfate
³Anionic surfactant B: C₁₁-C₁₃ linear alkylbenzene sulfonates
⁴SRP polymer: ethoxylated polyethyleneimine commercially available from BASF.

a) Stability

The stability of these samples under storing at 25° C. for 4 week was determined in accordance with Test 1: Stability test as described hereinabove. The results of stability for these samples are shown in Table 2. Only the liquid detergent compositions containing PEG having a molecular weight of less than 400 Daltons are stable.

TABLE 2

| | Sample 1 | Sample 2 | Sample 3 | Sample 4 | Sample 5 | Sample 6 | Sample 7 | Sample 8 |
|---|---|---|---|---|---|---|---|---|
| Stability | Pass | Pass | Pass | Fail | Fail | Pass | Pass | Pass |
| (25° C., 1 | | | | (Phase | (Phase | | | |
| week) | | | | separation) | separation) | | | |
| Molecular | 50 | 100 | 200 | 400 | 600 | — | 200 | 200 |
| weight of | Daltons | Daltons | Daltons | Daltons | Daltons | | Daltons | Daltons |
| PEG | | | | | | | | |
| Note | PEG50 | PEG100 | PEG200 | PEG400 | PEG600 | Non- | PEG200 | PEG200 |
| | + | + | + | + | + | aqueous | only | + |
| | Non- | Non- | Non- | Non- | Non- | Solvent | | Non- |
| | aqueous | aqueous | aqueous | aqueous | aqueous | only | | aqueous |
| | Solvent | Solvent | Solvent | Solvent | Solvent | | | Solvent |

b) Weeping Performance

The liquid detergent formulations of Samples 1 to 8 as mentioned above were prepared using standard mixing techniques and equipment known to those skilled in the art. Then, the liquid detergent compositions (˜10 ml) were encapsulated into compartment(s) of the unit dose by using a polyvinyl-alcohol-based film in which the PVA film and the shape of the unit dose were the same with CN Tides Laundry three-chamber side-by-side pouches available in market (July 2022).

The “weeping” phenomenon of unit dose articles containing liquid detergent formulations which were prepared as above was tested in accordance with Test 2: Weeping test for unit dose articles.

As shown in Table 3, it is found that the combination of PEG having a molecular weight of 200 to 600 Daltons and the non-aqueous solvent provides an improved weeping level. Particularly, the addition of PEG having a molecular weight of around 200 Daltons can provide a best “weeping” performance.

TABLE 3

| | Sample 1 | Sample 2 | Sample 3 | Sample 4 | Sample 5 | Sample 6 | Sample 7 | Sample 8 |
|---|---|---|---|---|---|---|---|---|
| Weeping | Medium | Medium | Light to | Light to | Light to | Medium | Light to | Light to |
| level at | | | Medium | Medium | Medium | | Medium | Medium |
| normal | | | | | | | | |
| condition | | | | | | | | |
| (RT, open | | | | | | | | |
| bag) | | | | | | | | |
| Weeping | Heavy | Medium | Light to | Medium | Light to | Medium | Medium | Light to |
| level at | | | Medium | | Medium | | | Medium |
| worst | | | | | | | | |
| condition | | | | | | | | |
| (32° C. and | | | | | | | | |
| 80% RH) | | | | | | | | |
| Molecular | 50 Daltons | 100 | 200 | 400 | 600 | — | 200 | 200 |
| weight of | | Daltons | Daltons | Daltons | Daltons | | Daltons | Daltons |
| PEG | | | | | | | | |
| Note | PEG50 | PEG100 | PEG200 | PEG400 | PEG600 | Non- | PEG200 | PEG200 |
| | + | + | + | + | + | aqueous | only | + |
| | Non- | Non- | Non- | Non- | Non- | Solvent | | Non- |
| | aqueous | aqueous | aqueous | aqueous | aqueous | only | | aqueous |
| | Solvent | Solvent | Solvent | Solvent | Solvent | | | Solvent |

c) Physical Property

Similarly as in b), the liquid detergent formulations of Samples 1 to 7 were prepared using standard mixing techniques and equipment known to those skilled in the art.

The impact of polyethylene glycol addition in the liquid detergent composition of the unit dose articles on water soluble film physical properties was assessed for the samples as above in accordance with Test 3: Physical properties test for film in unit dose articles as described hereinabove. Too much swelling yields floppy pouches. Too much de-swelling would make the pouches more sensitive for breakage. No swelling/no de-swelling was preferred.

As shown below, the combination of PEG having a molecular weight of from 100 to 600 Daltons and the non-aqueous solvent as shown in Samples 3 to 5 in the liquid detergent composition can provide an acceptable swelling performance. Preferably, when PEG has a molecular weight of from 200 to 600 Daltons, the physical property of the film is more improved.

TABLE 4

| | Sample 1 | Sample 2 | Sample 3 | Sample 4 | Sample 5 | Sample 6 | Sample 7 |
|---|---|---|---|---|---|---|---|
| Film volume | 15% | 8% | 5% | 2% | 0% | 9% | −9% |
| increase | | | | | | | |
| (%) | | | | | | | |
| Molecular | 50 Daltons | 100 | 200 | 400 | 600 | — | 200 |
| weight of | | Daltons | Daltons | Daltons | Daltons | | Daltons |
| PEG | | | | | | | |
| Note | PEG50 | PEG100 | PEG200 | PEG400 | PEG600 | Non- | PEG200 |
| | + | + | + | + | + | aqueous | only |
| | Non- | Non- | Non- | Non- | Non- | Solvent | |
| | aqueous | aqueous | aqueous | aqueous | aqueous | only | |
| | Solvent | Solvent | Solvent | Solvent | Solvent | | |

Overall, although PEG200 only shows a not bad stability and weeping performance, it shows an unacceptable physical property; and although non-aqueous solvent only shows acceptable stability, the weeping performance is only medium (i.e., not as good as the combination of PEG 100 to 400 and the non-aqueous solvent) and the physical property is not as good as the combination of PEG and the non-aqueous solvent. As such, it is surprisingly found that the combination of PEG having a molecular weight around 200 Daltons (e.g. from 150 to 300 Daltons) and the non-aqueous solvent provides an improved balance among the stability, physical property and weeping performance level.

### Example 2: Improved Weeping Performance of Unit Dose Articles Containing PEG 150 to 300, a Non-Aqueous Solvent and a Relatively Low Water Level

The following liquid detergent formulations were prepared using standard mixing techniques and equipment known to those skilled in the art. Samples 3 and 9 to 11 contain different water level (10.3% vs 15.0%).

TABLE 5

| Ingredients | | | | |
|---|---|---|---|---|
| (weight %) | Sample 3 | Sample 9 | Sample 10 | Sample 11 |
| Nonionic | 13.5 | 13.5 | 13.5 | 13.5 |
| Surfactant¹ | | | | |
| Anionic | 9.4 | 9.4 | 9.4 | 9.4 |
| surfactant A² | | | | |
| Anionic | 19.9 | 19.9 | 19.9 | 19.9 |
| surfactant B³ | | | | |
| Fatty Acid | 6.5 | 6.5 | 6.5 | 6.5 |
| MEA | 6.7 | 6.7 | 6.7 | 6.7 |
| SRP polymer⁴ | 5.6 | 5.6 | 5.6 | 5.6 |
| Potassium sulfite | 0.4 | 0.4 | 0.4 | 0.4 |
| 1,2-propanediol | 3.4 | 2.0 | 4.0 | 8.0 |
| Glycerine | 5.3 | 6.0 | 2.0 | 2.0 |
| Polyethylene | 14.6 | 12.0 | 14.0 | 10.0 |
| glycol (PEG) 200 | | | | |
| Water | 10.3 | 15.0 | 15.0 | 15.0 |
| Misc. | balance | balance | balance | balance |

¹Nonionic surfactant: C₁₂—C₁₄ ethoxylated alcohol
²Anionic surfactant A: C₁₂—C₁₄ alkyl ethoxylated sulfate
³Anionic surfactant B: C₁₁—C₁₃ linear alkylbenzene sulfonates
⁴SRP polymer: ethoxylated polyethyleneimine commercially available from BASF.

The liquid detergent formulations of Samples 3 and 9 to 11 as mentioned above were prepared using standard mixing techniques and equipment known to those skilled in the art. Then, the liquid detergent compositions (˜10 ml) were encapsulated into compartment(s) of the unit dose by using a polyvinyl-alcohol-based film in which the PVA film and the shape of the unit dose were the same with CN Tides Laundry three-chamber side-by-side pouches available in market (July 2022).

The “weeping” phenomenon of unit dose articles containing liquid detergent formulations which were prepared as above was tested in accordance with Test 2: Weeping test for unit dose articles.

As shown in Table 6, it is found that the unit does containing PEG 150 to 300, a non-aqueous solvent and a relatively low water level provides an improved weeping level.

TABLE 6

| | Sample 3 | Sample 9 | Sample 10 | Sample 11 |
|---|---|---|---|---|
| Weeping level at | Light to | Medium | Medium | Medium |
| worst condition | Medium | | | |
| (32° C. and 80% RH) | | | | |

### Example 3: Exemplary Formulations of Unit Dose Laundry Detergent Compositions Containing PEG

The exemplary formulations shown in Table 5 are made for unit dose laundry detergent. These compositions are encapsulated into compartment(s) of the unit dose by using a polyvinyl-alcohol-based film.

TABLE 7

| Ingredients | | | | | | | | |
|---|---|---|---|---|---|---|---|---|
| (weight %) | Sample a | Sample b | Sample c | Sample d | Sample e | Sample f | Sample g | Sample h |
| Nonionic | — | 30 | 5 | 10 | 10 | 30 | 20 | 10 |
| Surfactant¹ | | | | | | | | |
| Anionic | 15 | 5 | 5 | 25 | 5 | 10 | 10 | 5 |
| surfactant A² | | | | | | | | |
| Anionic | 25 | 10 | 30 | 9 | 20 | 10 | 5 | 9 |
| surfactant B³ | | | | | | | | |
| Amine Oxide | — | — | 3 | — | 5 | — | — | 10 |
| Fatty Acid | 8 | 10 | 2 | 8 | 10 | 5 | 5 | 2 |
| MEA | 10 | — | 9 | — | 8 | 7 | 6 | 1 |
| NaOH | I | 2 | — | 4 | — | — | — | 1 |
| Citric Acid | 1 | — | 2 | 0.5 | 2 | 3 | 3 | — |
| Perfume | 0.5 | 0.5 | 1 | 3 | 5 | 0.5 | 9 | 3 |
| Soil | — | 5 | 10 | 3 | — | — | 5 | — |
| suspension | | | | | | | | |
| polymer⁴ | | | | | | | | |
| 1,2- | 25 | 0 | 2 | 11 | 15 | 8 | 5 | 20 |
| propanediol | | | | | | | | |
| Glycerine | — | 15 | 5 | 10 | 5 | 8 | 15 | 8 |
| Glycol ether | 5 | — | — | 4 | — | — | — | 5 |
| Dipropylene | 5 | — | — | 5 | — | — | 5 | 10 |
| glycol | | | | | | | | |
| Polyethylene | 2 | 10 | 20 | 2 | 10 | 8 | 5 | 10 |
| glycol (PEG) | | | | | | | | |
| Water | 8 | 10 | 12 | 5 | 6 | 10 | 8 | 12 |
| Misc. | balance | balance | balance | balance | balance | balance | balance | balance |
| Molecular | 200 | 250 | 150 | 200 | 300 | 200 | 300 | 200 |
| weight of | Daltons | Daltons | Daltons | Daltons | Daltons | Daltons | Daltons | Daltons |
| PEG | | | | | | | | |

¹Nonionic surfactant: C₁₂-C₁₄ ethoxylated alcohol
2Anionic surfactant A: C₁₂-C₁₄ alkyl ethoxylated sulfate
³Anionic surfactant B: C₁₁-C₁₃ linear alkylbenzene sulfonates
⁴SRP polymer: ethoxylated polyethyleneimine commercially available from BASF.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble unit dose article comprising a water-soluble film and a liquid laundry detergent composition wrapped with the water-soluble film, wherein the liquid laundry detergent composition comprises from 1% to 25% by weight of the composition of polyethylene glycol having a weight average molecular weight of from about 150 to about 300 Daltons, and from 0.1% to 30% by weight of the composition of a non-aqueous solvent, wherein the liquid laundry detergent composition comprises less than 15% by weight of the composition of water.

2. The water-soluble unit dose article according to claim 1, wherein the polyethylene glycol is present at a level of from 4% to 23%, by weight of the composition.

3. The water-soluble unit dose article according to claim 1, wherein the polyethylene glycol has a weight average molecular weight of from about 150 to about 250 Daltons.

4. The water-soluble unit dose article according to claim 1, wherein said non-aqueous solvent is present at a level of from 1% to 25%, by weight of the composition.

5. The water-soluble unit dose article according to claim 1, wherein said non-aqueous solvent comprises 1,2-propanediol at a level of from 0.1% to 15%, by weight of the composition.

6. The water-soluble unit dose article according to claim 1, wherein said non-aqueous solvent comprises glycerine at a level of from 0.1% to 10%, by weight of the composition.

7. The water-soluble unit dose article according to claim 1, wherein the liquid laundry detergent composition further comprises from 0.1% to 70%, by weight of the composition, of a surfactant.

8. The water-soluble unit dose article according to claim 1, wherein the liquid laundry detergent composition further comprises from 1% to 30%, by weight of the composition, of C₆-C₂₀ LAS.

9. The water-soluble unit dose article according to claim 1, wherein the liquid laundry detergent composition further comprises from 1% to 20%, by weight of the composition, of a C₆-C₂₀ alkyl ethoxylated sulfate having a weight average degree of ethoxylation ranging from 1 to 7.

10. The water-soluble unit dose article according to claim 1, wherein the liquid laundry detergent composition further comprises from 1% to 60%, by weight of the composition, of C₆-C₂₀ alkoxylated alcohol having a weight average degree of alkoxylation ranging from 1 to 20.

11. The water-soluble unit dose article according to claim 1, wherein the liquid laundry detergent composition further comprises from 1% to 30%, by weight of the composition, of an amine oxide.

12. The water-soluble unit dose article according to claim 1, wherein the liquid laundry detergent composition further comprises from 0.1% to 10%, by weight of the composition, of a fatty acid.

13. The water-soluble unit dose article according to claim 1, wherein the liquid laundry detergent composition comprises:
a) from 10% to 20%, by weight of the composition, of polyethylene glycol having a weight average molecular weight of from about 150 to about 250 Daltons,
b) from 5% to 20%, by weight of the composition, of a non-aqueous solvent which comprises 1,2-propanediol and glycerine, and
c) from 30%% to 45%, by weight of the composition, of a surfactant which comprises a C₆-C₂₀ LAS, a C₆-C₂₀ AAS, and a C₆-C₂₀ alkoxylated alcohol having a weight average degree of ethoxylation ranging from 5 to 10.

14. The water-soluble unit dose article according to claim 1, wherein the liquid laundry detergent composition comprises less than 14%, by weight of the composition, of water.

15. The water-soluble unit dose article according to claim 1, wherein the water-soluble film is a polymeric water-soluble film.

16. The water-soluble unit dose article according to claim 1, wherein the liquid laundry detergent composition comprises an adjunct ingredient selected from hueing dyes, polymers, builders, dye transfer inhibiting agents, dispersants, enzymes, enzyme stabilizers, catalytic materials, bleach, bleach activators, polymeric dispersing agents, anti-redeposition agents, suds suppressors, aesthetic dyes, opacifiers, perfumes, perfume delivery systems, structurants, hydrotropes, processing aids, pigments, and mixtures thereof.
